(19) United States
(12) Patent Application Publication
(10) Pub. No.: US 2015/0049173 A1
(43) Pub. Date: Feb. 19, 2015

(54) METHOD AND APPARATUS FOR CAPTURING STEREOSCOPIC IMAGES

(71) Applicant: Samsung Electronics Co., Ltd., Gyeonggi-do (KR)

(72) Inventors: Jeonghun KIM, Gyeonggi-do (KR); Jungwoo LEE, Gyeonggi-do (KR); Keumju JANG, Seoul (KR)

(21) Appl. No.: 14/449,354

(22) Filed: Aug. 1, 2014

(30) Foreign Application Priority Data
Aug. 19, 2013 (KR) 10-2013-0097772

(51) Int. Cl. H04N 13/02

(52) U.S. Cl. CPC H04N 13/0207; H04N 2213/001
USPC 348/49

(57) ABSTRACT

An apparatus is provided for capturing a stereoscopic image comprising: a housing having a first image-capturing hole and a second image-capturing hole separated from each other by a predetermined distance, wherein the first image-capturing hole and the second image-capturing hole respectively project a first image and a second image onto a camera module of an electronic device; a first reflector mounted on one inner wall of the housing for reflecting the first image; a second reflector mounted on another inner wall of the housing for reflecting the second image; and a light delivery portion for sequentially delivering the first image and the second image to the camera module.

### CROSS-REFERENCE TO RELATED APPLICATION

This application claims priority from and the benefit under 35 U.S.C. §119(a) of Korean Patent Application No. 10-2013-0097772, filed on Aug. 19, 2013, which is hereby incorporated by reference for all purposes as if fully set forth herein.

### BACKGROUND

1. Field of the Invention

The present disclosure relates to electronic devices and more particularly to a method and apparatus for capturing stereoscopic images.

2. Description of the Prior Art

Recently, the production of various 3D image contents such as movies, educational materials, advertisements, and the like has increased. With the spread of 3D Television (TVs), the size of the market for 3D TV-related content is expected to expand.

Stereoscopic imaging uses the principle of binocular parallax such that a human being sees the world with two eyes. Accordingly, in order to obtain a stereoscopic image, a process is performed for capturing an object to be captured (i.e., a subject) by using two image cameras matched to the left and right eyes of the human being, synchronizing a left image with a right image, and combining the left image and the right image to form a 3D image.

FIG. 1 depicts an example of a 3D-capable electronic device including two camera modules. As illustrated, the electronic device 10 includes camera modules 12 and 14 which are spaced apart from one another. However, this arrangement has several disadvantages. For example, when the two camera modules 12 and 14 are mounted on the electronic device 10 as illustrated in FIG. 1, due to the volume of the two camera modules 12 and 14, the size of the electronic becomes larger which leads to an increase in the electronic device's price. In addition, having multiple camera modules results in increased power consumption because the electronic device 10 needs additional power to drive the camera modules. And also, in some instances, the dual-camera arrangement may turn away potential customers who have no desire to capture stereoscopic images. Accordingly, the need exists for new techniques for providing 3D imaging capabilities to electronic devices.

### SUMMARY

The present disclosure addresses this need. addressees at least some of these disadvantages. According to one aspect of the disclosure, an apparatus is provided for capturing a stereoscopic image comprising: a housing having a first image-capturing hole and a second image-capturing hole separated from each other by a predetermined distance, wherein the first image-capturing hole and the second image-capturing hole respectively project a first image and a second image onto a camera module of an electronic device; a first reflector mounted on one inner wall of the housing for reflecting the first image; a second reflector mounted on another inner wall of the housing for reflecting the second image; and a light delivery portion for sequentially delivering the first image and the second image to the camera module.

According to another aspect of the disclosure, a method is provided for capturing a stereoscopic image by using an auxiliary apparatus for capturing the stereoscopic image, the method comprising: detecting whether the auxiliary apparatus for capturing the stereoscopic image on a front surface of a camera module that is part of an electronic device; establishing a connection between the electronic device and the auxiliary apparatus for capturing the stereoscopic image; acquiring a first image and a second image via the auxiliary apparatus for capturing the stereoscopic image; and generating the stereoscopic image based on the first image and second image.

### BRIEF DESCRIPTION OF THE DRAWINGS

The above features and advantages of the present disclosure will be more apparent from the following detailed description in conjunction with the accompanying drawings, in which:

FIG. 1 is a view illustrating an electronic device including two camera modules in order to capture a 3D image according to the related art;

FIG. 2 is a block diagram illustrating an example of a configuration of an electronic device and that of an auxiliary apparatus for capturing a stereoscopic image, according to aspects of the present disclosure;

FIG. 3 and FIG. 4 are views each illustrating an example of an auxiliary apparatus for capturing a stereoscopic image according to aspects of the present disclosure; and

FIG. 5 is a flowchart illustrating an example of a method for capturing a stereoscopic image by using an auxiliary apparatus for capturing a stereoscopic image according to aspects present disclosure.

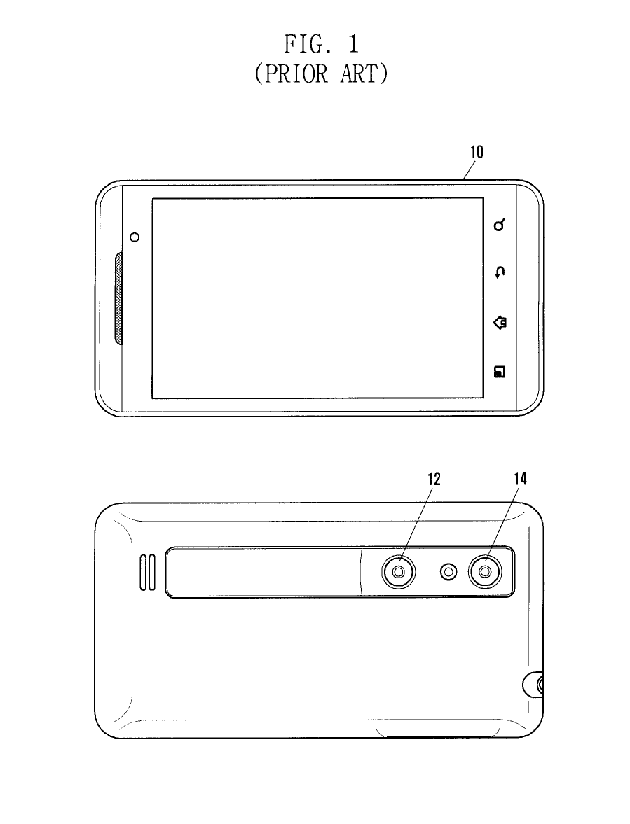

### DETAILED DESCRIPTION

Hereinafter, an embodiment of the present invention will be described in detail with reference to the accompanying drawings.

In describing embodiments of the present disclosure, a description will be omitted of the technical contents that are well known in the technical field, to which the present disclosure pertains, and are not directly related to the present disclosure. Also, the descriptions of the component elements that have substantially identical configurations and functions will be omitted. For the same reason, in the accompanying drawings, some elements may be exaggerated, omitted, or schematically illustrated, and one or more elements may not be drawn up to scale.

Prior to making a detailed description of the present disclosure, the terms and words used in the present specification and claims should not be interpreted as being limited to their typical meaning based on the dictionary definitions thereof, but should be interpreted to have the meaning and concept relevant to the technical spirit of the present disclosure. Accordingly, the embodiments described in the present specification and constructions shown in the drawings are only examples, and do not represent all technical spirits of the present disclosure. Therefore, it should be understood that various equivalents and modified embodiments capable of replacing these embodiments may exist at the time when this application was filed.

According to aspects of the disclosure, the concepts and techniques disclosed herein may be applied to all information communication devices and multimedia devices, such as a Moving Picture Experts Group Audio Layer-3 (mp3) player, a Portable Multimedia Player (PMP), a Personal Digital Assistant (PDA), a tablet Personal Computer (PC), a mobile phone, a smart phone, etc. and may be applied to the applications of them.

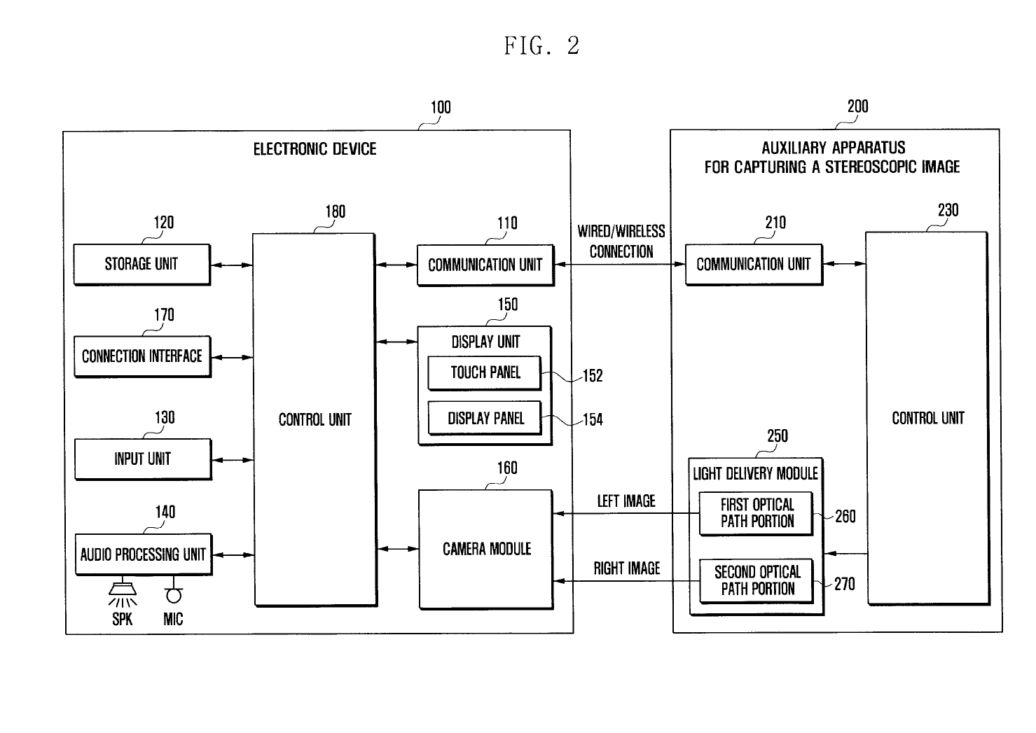

FIG. 2 is a block diagram illustrating an example of a configuration of an electronic device and that of an auxiliary apparatus for capturing a stereoscopic image, according to an aspect of the present disclosure.

As illustrated, the electronic device 100 may include a communication unit 110, a storage unit 120, an input unit 130, an audio processing unit 140, a display unit 150, a camera module 160, a connection interface 170, and a control unit 180.

The connection interface 170 is an interface, to which at least one stereoscopic image output apparatus may be connected. For example, the stereoscopic image output apparatus may be a smart TV, a smart monitor, and/or any other suitable electronic terminal, and may be connected to the connection interface 170. The connection interface 170 may not only output stereoscopic image data to the stereoscopic image output apparatus, but may also deliver an input signal, that the stereoscopic image output apparatus generates, to the control unit 180.

The communication unit 110 is configured to support a communication function of the electronic device 100. Particularly, according to an aspect of the present disclosure, the communication unit 110 may include one or more modules which enable wired/wireless communication between the electronic device 100 and the auxiliary apparatus 200 for capturing a stereoscopic image.

Specifically, the communication unit 110 of the electronic device 100 may be connected to a communication unit 210 of the auxiliary apparatus 200 for capturing a stereoscopic image through a wired serial connection interface such as a Universal Serial Bus (USB) interface, a Universal Asynchronous Receiver/Transmitter (UART) interface, and the like, or through at least one of wireless interfaces according to Bluetooth, Zigbee, Ultra Wide Band (UWB), Radio Frequency IDentification (RFID), Infrared Data Association (IrDA), Wireless Application Protocol (WAP), and Near Field Communication (NFC). The electronic device 100 may transmit and receive data to/from the auxiliary apparatus 200 for capturing a stereoscopic image via the above-described communication link.

The storage unit 120 is a secondary memory unit, and for example, may include a storage medium of at least one type from among a flash memory type, a hard disk type, a multimedia card micro type, a memory card type (e.g., a Secure Digital (SD) or eXtreme Digital (XD) memory card), a Random Access Memory (RAM) type, a Static RAM (SRAM) type, a Read Only Memory (ROM) type, a Programmable ROM (PROM) type, an Electrically Erasable PROM (EEPROM) type, a Magnetic RAM (MRAM) type, a magnetic disk type, an optical disk type, and the like. The electronic device 100 may also operate in relation to a web storage which performs a storage function of the storage unit 120 on the Internet.

Under the control of the control unit 180, the storage unit 120 may store data (e.g., stereoscopic image data) that the electronic device 100 has generated, or data (e.g., a stereoscopic image file, etc.) received from the outside through the communication unit 110. The storage unit 120 stores an Operating System (OS) for operating the electronic device 100 and various programs.

Particularly, according to an aspect of the present disclosure, the storage unit 120 stores an application for acquiring stereoscopic images. Additionally or alternatively, the storage unit 120 may store an embedded application and a third party application. The term “embedded application” refers to an application basically installed in the electronic device 100. For example, the embedded application may be an environment setting program, a browser, an e-mail, an instant messenger, and the like. As is well known, the term “third party application” refers to an application which may be downloaded from an online market and installed in the electronic device 100, and there are various types of third party applications. The third party application is freely installed and controlled. When the electronic device 100 is turned on, the booting program is first loaded into a main memory (e.g., a Random Access Memory (RAM)) of the control unit 180. The booting program loads the OS into the main memory so as to enable the electronic device 100 to operate. Also, the OS loads various programs into the main memory, and executes the loaded programs. Particularly, when the access of an external device has been detected, the OS loads a data communication program into the main memory, and executes the loaded data communication program. The relevant booting and loading are a widely-known technology in a computer system, and thus a detailed description thereof will be omitted.

The input unit 130 generates input data that a user inputs in order to control execution in the electronic device 100. The input unit 130 may include a keypad, a dome switch, a touch pad (static pressure/capacitance), a jog wheel, a jog switch, and the like. The input unit 130 may be implemented in the form of buttons on an outer surface of the electronic device 100, and some buttons may be implemented by a touch panel.

Particularly, according to an aspect of the present disclosure, the input unit 130 may be implemented as an input module for inputting a command for executing a stereoscopic image capturing mode of the electronic device 100, and a command for requesting the camera module 160 to capture an image during execution of the stereoscopic image capturing mode.

The audio processing unit 140 provides an audio signal, which has been received from the control unit 180, to a speaker (SPK), and provides an audio signal such as a voice and the like, which has been received from a microphone (MIC), to the control unit 180. According to the control of the control unit 180, the audio processing unit 140 converts sound data, such as voice/sound, into an audible sound and outputs the audible sound, through the SPK. According to the control of the control unit 180, the audio processing unit 140 converts an audio signal such as a voice and the like, which has been received from the MIC, into a digital signal, and provides the digital signal to the control unit 180.

The SPK may output audio data received from the communication unit 110, audio data received as input from the from the MIC, or audio data stored in the storage unit 120, in a call mode, a recording mode, a voice recognition mode, a broadcast receiving mode, an image capturing mode, a situation recognition service execution mode, and the like. The SPK may output sound signals related to functions (e.g., the feedback of situation information according to the execution of an action, the reception of a call connection, the transmission of a call connection, image capturing, the reproduction of media content such as a music file and a moving image file, etc.) performed by the electronic device 100.

Particularly, according to an aspect of the present disclosure, the SPK may be implemented as a sound output module for outputting a sound signal delivered together with a stereoscopic image.

The MIC receives, as input, a sound signal from the outside in the call mode, the recording mode, the voice recognition mode, the image capturing mode, a voice recognition-based dictation execution mode and the like, and processes the received sound signal into electrical voice data. In the call mode, the processed voice data may be converted into a form transmissible to a mobile communication base station through the mobile communication module, and the voice data in the form transmissible to the mobile communication base station may be output. Various noise removal algorithms may be implemented in the MIC in order to remove noise generated in process of receiving the external sound signal as input.

The display unit 150, for example, may be implemented by a touch screen, and performs functions of the input unit and the display unit in order to interact with the user. Specifically, the display unit 150 may include a touch panel 152 and a display panel 154. The touch panel 152 may be placed on the display panel 154. The touch panel 152 generates an analog signal in response to a user gesture (e.g., a touch event) thereon, Analog-to-Digital (A/D) converts the generated analog signal into a digital signal, and provides the digital signal to the control unit 180.

Under the control of the control unit 180, the display panel 154 converts image data, which has been received as input from the control unit 180, into an analog signal, and displays the converted analog signal. Specifically, the display panel 154 may display various screens (e.g., a lock screen, a home screen, an application (abbreviated as “App”) execution screen, a keypad, etc.) according to the use of the electronic device 10. The display panel 154 may be implemented by a Liquid Crystal Display (LCD), an Organic Light Emitting Diode (OLED) display, and/or an Active Matrix Organic Light Emitting Diode (AMOLED) display.

Particularly, according to an aspect of the present disclosure, the display unit 150 may output at least one of a left image and a right image received during the stereoscopic image capturing mode, and a stereoscopic image generated by editing the left and right images.

The camera module 160 may include an image sensor, a circuit board, an image-capturing lens 162, and the like. When a left image and a right image are alternately incident on the image-capturing lens 162 from the auxiliary apparatus 200 for capturing a stereoscopic image, the left and right images incident on the image-capturing lens 162 may be converted into electrical signals through the image sensor, and the converted electrical signals may be delivered to the circuit board. The left image and right image data delivered to the circuit board may be edited by the control unit 180, and may be generated as a stereoscopic image. The generated stereoscopic image may be displayed on the display unit 150, or may be delivered through the connection interface 170 and may be output by an external stereoscopic image output device.

The control unit 180 controls overall execution in the electronic device 100 and a signal flow between the internal elements of the electronic device 100, processes data, and controls the supply of power from a battery to the elements of the electronic device 100. The control unit 180 may include one or more of a main memory which stores an application program and the OS, a cache memory which temporarily stores data to be written to the storage unit 120 and temporarily stores data read from the storage unit 120, a Central Processing Unit (CPU), a Graphic Processing Unit (GPU), a Field-Programmable Gate Array (FPGA), an Application-Specific Integrated Circuit (ASIC), and/or any other suitable type of processing circuitry. Here, the OS manages computer resources, such as the CPU, the GPU, the main memory, the auxiliary memory and the like, while serving as an interface between hardware and a program.

Specifically, the OS operates the electronic device, determines the order of tasks, and controls an arithmetic operation of the CPU and that of the GPU. Also, the OS performs a function of controlling the execution of an application program, a function of managing the storage of data and files, and the like.

Meanwhile, as is well known, the CPU is a core control unit of a computer system which performs calculations and comparisons of data, the interpretation and execution of instructions, and the like. In place of the CPU, the GPU is a graphic control unit which performs calculations and comparisons of graphic-related data, and the interpretation and execution of instructions, and the like. In each of the CPU and the GPU, two or more independent cores (e.g., a quad-core) may be integrated into one package composed of a single Integrated Circuit (IC). Alternatively, the CPU and the GPU may be integrated into one chip (i.e., System on Chip (SoC)). Alternatively, the CPU and the GPU may be packaged in a multi layer. Meanwhile, a configuration including the CPU and the GPU may be referred to as an “Application Processor (AP).”

Particularly, according to an aspect of the present disclosure, the control unit 180 has a configuration for controlling various signal flows, the collection and output of information, and the like, in order to execute the stereoscopic image capturing mode.

The control unit 180 may execute the stereoscopic image capturing mode at a request for the stereoscopic image capturing mode. To this end, the control unit 180 may drive the camera module 160, and may execute an application for stereoscopic image capturing.

Then, the control unit 180 may determine whether the auxiliary apparatus 200 for capturing a stereoscopic image is connected to the electronic device 100. Specifically, the control unit 180 may determine whether the auxiliary apparatus 200 for capturing a stereoscopic image is physically connected to a front surface of the camera module 160 of the electronic device 100. To this end, a particular sensor for sensing a state of being mounted on the camera module 160 may be installed in a part of the auxiliary apparatus 200 for capturing a stereoscopic image. Alternatively, a switch that enables the user to select on/off for mounting the auxiliary apparatus 200 for capturing a stereoscopic image on the camera module 160 may be installed in the part thereof. The control unit 180 may determine whether the auxiliary apparatus 200 for capturing a stereoscopic image is physically connected to the front surface of the camera module 160, based on a signal delivered by the particular sensor or the switch. Alternatively, when communication is connected between the electronic device 100 and the auxiliary apparatus 200 for capturing a stereoscopic image, the control unit 180 may determine the communication connection between them as a state in which the auxiliary apparatus 200 for capturing a stereoscopic image is mounted on the electronic device 100.

When the camera module 160 is driven, the control unit 180 determines whether the current the shutter speed to of the camera module 160 satisfies a predetermined threshold. Specifically, the control unit 180 may acquire image capturing information from the camera module 160, and may determine whether the shutter speed is lower than or equal to a preset particular reference time value based on the acquired image capturing information. The particular reference time value may be set to be less than or equal to 1/100 seconds, in which an image difference may be large between a left image and a right image acquired through the auxiliary apparatus 200 for capturing a stereoscopic image.

When it is determined that the shutter speed satisfies the threshold, the control unit 180 acquires an image through the image-capturing lens 162. In contrast, when it is determined that the shutter speed does not satisfy the threshold, the control unit 180 changes an image capturing setting so as to cause the shutter speed to be lower than or equal to the particular reference time value. For example, the control unit 180 may change the image capturing setting by adjusting at least one of an aperture, a shutter, and an ISO value.

Additionally or alternatively, the control unit 180 uses the camera module 160 to acquire left and right images, generates a stereoscopic image based on the acquired left and right images, and stores the generated stereoscopic image in the storage unit 120.

The auxiliary apparatus 200 for capturing a stereoscopic image includes a communication unit 210, a control unit 230, and a light delivery module 250. The light delivery module 250 includes a first optical path portion 260 and a second optical path portion 270.

The communication unit 210 may include one or more modules which enable wired/wireless communication between the auxiliary apparatus 200 for capturing a stereoscopic image and the communication unit 110 of the electronic device 100. To this end, the communication unit 210 may include a wired serial connection interface, such as a USB interface, a UART interface, and the like. Alternatively, the communication unit 210 may include at least one of wireless interfaces according to Bluetooth, Zigbee, UWB, RFID, IrDA, WAP, and NFC.

When receiving an image capturing request signal from the electronic device 100, the control unit 230 may control an operation of the light delivery module 250. Specifically, when a left image and a right image are incident to the light delivery module 250, the control unit 230 may control the light delivery module 250 to separate the left image from the right image by using at least one of an optical method, a physical method, an electrical method and a magnetic method, and cause the left image and the right image, which are separated from each other, to be sequentially projected onto the image-capturing lens 162.

The first optical path portion 260 included in the light delivery module 250 is configured to acquire a left image, and has a configuration in which light passes through a left image-capturing hole 262, a left reflector 264 and a light delivery portion 252. Also, the second optical path portion 270 is configured to acquire a right image, and has a configuration in which light passes through a right image-capturing hole 272, a right reflector 274 and the light delivery portion 252.

Hereinafter, a structure of the auxiliary apparatus for capturing a stereoscopic image according to an aspect of the present disclosure will be described with reference to FIGS. 2 to 4.

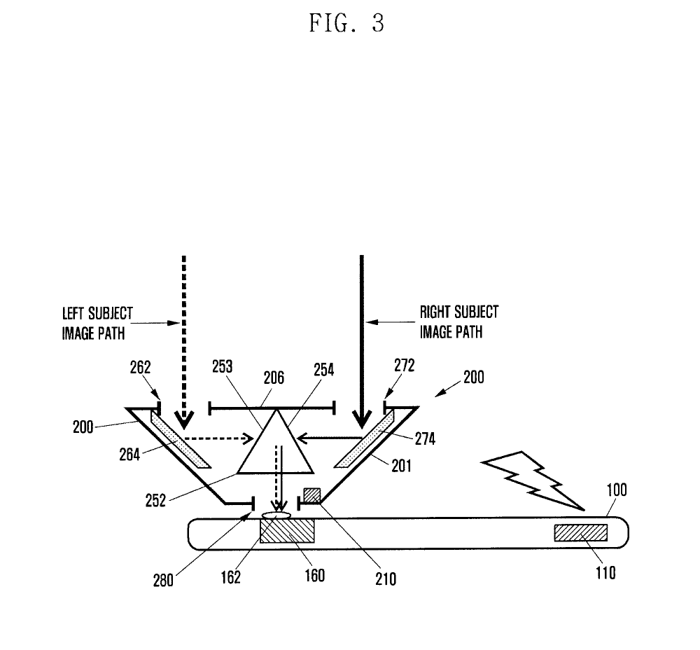

Referring to FIG. 3, according to an aspect of the present disclosure, the auxiliary apparatus 200 for capturing a stereoscopic image includes a housing 201, a left image-capturing hole 262, a left reflector 264, a right image-capturing hole 272, a right reflector 274, a light delivery portion 252, and an image outlet 280.

The housing 201 configured to accommodate optical elements can be made of a metallic material, a plastic-based synthetic resin, or a combination thereof.

The housing 201 may have a trapezoidal shape, in which one base faces a front surface of the camera module 160. Alternatively, the housing 201 may have any other suitable shape that permits the housing 201 to be capable of being mounted on the front surface of the camera module 160.

The left image-capturing hole 262 and the right image-capturing hole 272 are configured to allow a left image and a right image to be projected into the housing 201, respectively, and are both provided in the form of an opening at one surface of the housing 201. In some aspects, the left image-capturing hole 262 and the right image-capturing hole 272 may be separated from each other by a predetermined distance. Each of the left image-capturing hole 262 and the right image-capturing hole may be disposed on a different size of the image-capturing lens 162 of the camera module 160.

In FIG. 3, the housing 201 of the auxiliary apparatus 200 for capturing a stereoscopic image may be manufactured so as to be capable of changing the predetermined distance by which the left image-capturing hole 262 and the right image-capturing hole 272 are separated from each other. To this end, one surface 206 of the housing 201 between the left image-capturing hole 262 and the right image-capturing hole 272 may be formed in a structure in which one surface 206 is capable of being folded or unfolded. For example, the one surface 206 of the housing 201 between the left image-capturing hole 262 and the right image-capturing hole 272 may be provided in a structure in which multiple flat plates that are slidably connected to one another so as to permit the length of the surface to be increased and decreased. Accordingly, the distance between (and/or size of) left image-capturing hole 262 and the right image-capturing hole 272 can be increased when the one surface 206 is lengthened.

The left reflector 264 is configured to reflect the left image, which has been received through the left image-capturing hole 262, to the light delivery portion 252, and the right reflector 274 is configured to reflect the right image of the subject, which has been received through the right image-capturing hole 272, to the light delivery portion 252. The left reflector 264 and the right reflector 274 may be provided to be respectively attached to different inner walls of the housing 201. In an aspect of the present disclosure, consideration is given to a case in which the left reflector 264 and the right reflector 274 are respectively mounted on inner walls (i.e., left and right inner walls) of the housing 201, which face each other. The left reflector 264 and the right reflector 274 are both tilted by a predetermined angle in the direction of the light delivery portion 252. The predetermined angle, by which the left reflector 264 and the right reflector 274 are both tilted, may be set to allow the light, which has been incident on each reflector, to be reflected to the light delivery portion 252.

The light delivery portion 252 is configured to allow the left image and the right image, which have been respectively reflected by the left reflector 264 and the right reflector 274, to be sequentially projected onto the image-capturing lens 162. The light delivery portion 252 is provided on the inside of the housing 201 between the left reflector 264 and the right reflector 274.

Specifically, the light delivery portion 252 may include a triangular structure in which a bottom side of the triangle is parallel to the front surface of the camera module 160 with the front surface thereof as a reference. The light delivery portion 252 allows a left image, which is received through a left side of the triangle, to be projected on the image-capturing lens 162 via the bottom side of the triangle, and allows a right image, which is received t through a right side of the triangle, to be projected on the image-capturing lens 162 via the bottom side of the triangle.

In detail, the left side 253 of the light delivery portion 252 can immediately project the left image reflected with the left reflector 264 to the image-capturing lens 162 of the electronic device 100. In addition, the left side 253 of the light delivery portion 252 can transmit the left image reflected with the left reflector 264 through to the inside of the light delivery portion 252. The transmitted left image can be projected to the image-capturing lens 162 of the electronic device 100 with the mirror in the inside of the light delivery portion 252. The right side 254 of the light delivery portion 252 can immediately project the right image reflected with the right reflector 274 to the image-capturing lens 162 of the electronic device 100. In addition, the right side 254 of the light delivery portion 252 can transmit the right image reflected with the right reflector 274 through to the inside of the light delivery portion 252. The transmitted right image can be projected to the image-capturing lens 162 of the electronic device 100 with the mirror in the inside of the light delivery portion 252.

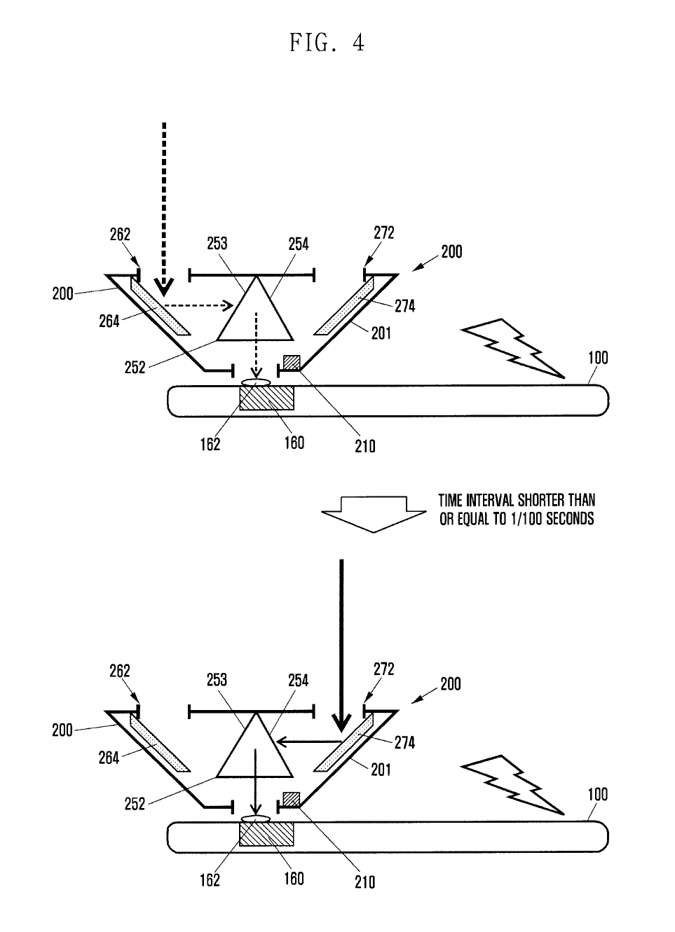

Referring to FIG. 4, the left image is an image which has been received the housing 201 through the left image-capturing hole 262 and is reflected by the left reflector 264 to the light delivery portion 252. The right image is an image which is received in the housing 201 through the right image-capturing hole 272 and is reflected by the right reflector 274 to the light delivery portion 252.

Then, the control unit 230 controls the light delivery portion 252, and controls the acquisition of the left image and the right image. To this end, the control unit 230 controls the projection of light through each of the left side 253 and the right side 254 of the triangle corresponding to the light delivery portion 252. Specifically, the control unit 230 may alternately block the left side 253 of the triangle and the right side 254 thereof, according to a frame cycle signal, and may alternately project the left image and the right image, which have been respectively incident through the left side 253 of the triangle and the right side 254 thereof, onto the bottom side of the triangle. At this time, the control unit 230 may block the left side 253 of the triangle and the right side 254 thereof through a physically-rotating shutter, or may electrically block a signal corresponding to light which has been incident through each of the left side 253 and the right side 254.

In detail, while the light delivery portion 252 projects the left image reflected from the left reflector 264 to the image-capturing image 162 using the left side 253 the control unit 230 blocks the right image-capturing hole 272 with the shielding film to prevent the right image from being transmitted to the light delivery portion 252. In addition, while the light delivery portion 252 is projecting the left image to the image-capturing lens 162, the control unit 230 shields the right side 254 with the shutter or applies an electric signal to the right side 254 to deactivate the right side 254 and prevent the right image from being transmitted to the light delivery portion 252.

While the light delivery portion 252 projects the right image reflected from the right reflector 254 to the image-capturing image 162 using the right side 254 the control unit 230 blocks the left image-capturing hole 262 with the shielding film to prevent the left image from being transmitted to the light delivery portion 252. In addition, while the light delivery portion 252 is projecting the right image to the image-capturing lens 162, the control unit 230 shields the left side 253 with the shutter or applies an electric signal to the left side 253 to deactivate the left side 253 and prevent the right image from being transmitted to the light delivery portion 252.

For example, when a setting of a recording frame is N frames per second, the control unit 230 performs a control operation for causing light to be alternately incident on the image-capturing lens 162 via the left side 253 and the right side 254 of the light delivery portion 252, so as to store each of a left image and a right image at N/2 frames per second.

In the present example, the control unit 230 may include a variable clock circuit capable of varying a speed, at which light incident through the left side 253 of the light delivery portion 252 and light incident through the right side 254 thereof are alternately projected, by using various internal frame frequencies although the frame signal is not received as input from the outside when a stereoscopic image is captured.

The image, that the light delivery portion 252 has projected, is incident from the inside of the housing 201 to the image-capturing lens 162 via the image outlet 280. When the auxiliary apparatus 200 for capturing a stereoscopic image is mounted on the electronic device 100, the image outlet 280 may be formed so as to face the image-capturing lens 162. The image outlet 280 may further include a particular lens so as to allow the image that the light delivery portion 252 delivers, to be enlarged before vertically passing through the image-capturing lens 162.

The above-described auxiliary apparatus 200 for capturing a stereoscopic image may be connected to a part of the electronic device 100 through a strap and the like, and may be provided so as to be attachable/detachable to/from the electronic device 100 according to the purpose of use of the user.

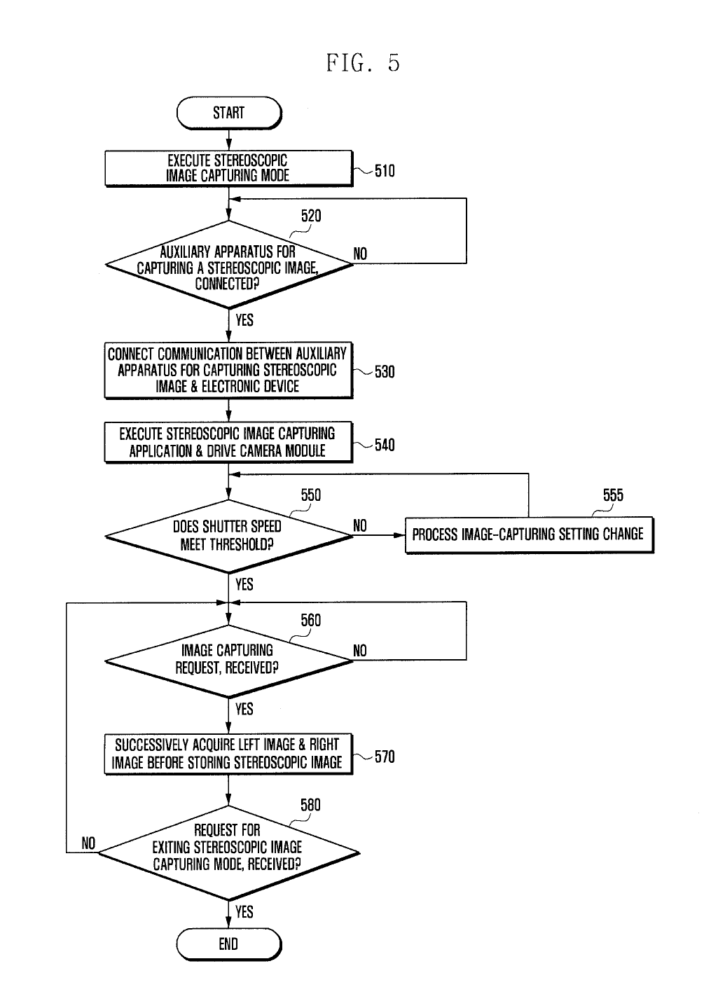

FIG. 5 is a flowchart illustrating an example of a method for capturing a stereoscopic image by using an auxiliary apparatus for capturing a stereoscopic image according to aspects of the present disclosure.

Referring to FIG. 5, a description is made of the method for capturing a stereoscopic image according to an aspect of the present disclosure. First, when power is supplied, the control unit 180 performs a control operation for initializing the elements of the electronic device 100 by using the supplied power.

When the initialization has been completed, in operation 510, the control unit 180 may identify the execution of a stereoscopic image capturing mode. The stereoscopic image capturing mode is a mode for acquiring a 3D image by using the camera module 160 included in the electronic device 100, and may be set to be executed automatically or at a request from the user, when the camera module 160 is turned on or when an application is executed which is related to an operation of the camera module 160.

In operation 520, the control unit 180 may determine whether the auxiliary apparatus 200 for capturing a stereoscopic image is connected to the electronic device. Specifically, the control unit 180 may determine whether the auxiliary apparatus 200 for capturing a stereoscopic image is physically connected to the front surface of the camera module 160 of the electronic device. To this end, a particular sensor for sensing a state of being mounted on the camera module 160 may be installed in a part of the auxiliary apparatus 200 for capturing a stereoscopic image. Alternatively, a switch that enables the user to select on/off for mounting the auxiliary apparatus 200 for capturing a stereoscopic image on the camera module 160 may be installed in the part thereof. The control unit 180 may determine whether the auxiliary apparatus 200 for capturing a stereoscopic image is physically connected to the front surface of the camera module 160, based on a signal delivered by the particular sensor or the switch. Alternatively, the control unit 180 may determine whether the auxiliary apparatus 200 for capturing a stereoscopic image is physically connected to the electronic device 100, based on whether communication is connected between the electronic device 100 and the auxiliary apparatus 200 for capturing a stereoscopic image.

At this time, the auxiliary apparatus 200 for capturing a stereoscopic image may be connected to at least one of an ear jack plug insertion hole and a USB connector of the electronic device 100, and may be supplied with power from the electronic device 100 through an electrical connection of the auxiliary apparatus 200 for capturing a stereoscopic image to the electronic device 100, simultaneously with implementing the physical connection of the auxiliary apparatus 200 for capturing a stereoscopic image to the electronic device 100.

In operation 530, the control unit 180 initiates communication between the auxiliary apparatus 200 for capturing a stereoscopic image and the electronic device 100. The communication between the auxiliary apparatus 200 for capturing a stereoscopic image and the electronic device 100 take place over at least one of a wired connection and a wireless connection. Specifically, the auxiliary apparatus 200 for capturing a stereoscopic image may be connected to the electronic device 100 through a wired serial connection interface such as a USB interface, a UART interface, and the like, or through at least one of wireless interfaces according to Bluetooth, Zigbee, UWB, RFID, IrDA, WAP, and NFC.

In operation 540, the control unit 180 executes an application which executes stereoscopic image capturing, and drives the camera module 160. In some implementations, when the auxiliary apparatus 200 for capturing a stereoscopic image is mounted on the front surface of the camera module 160, the application which executes stereoscopic image capturing may be automatically activated. To this end, the electronic device 100 may previously store information on a related application list, when the auxiliary apparatus 200 for capturing a stereoscopic image is connected to the camera module 160 of the electronic device 100. The information on the related application list may be set by the user of the electronic device 100 or the electronic device's manufacturer. The control unit 180 opens an optical path so as to allow the image incident onto the front surface of the camera module 160 to be incident through the image-capturing lens 162 of the camera module 160.

In operation 550, the control unit 180 determines whether the shutter speed of the camera module satisfies a threshold. Specifically, the control unit 180 may acquire image capturing information from the camera module 160, and may determine whether the shutter speed satisfies the threshold based on the acquired image capturing information. For example, the threshold be set to be less than or equal to 1/100 seconds, in which an image difference may be large between a left image and a right image acquired through the auxiliary apparatus 200 for capturing a stereoscopic image.

If the right image is captured after the threshold was passed after the left image had been captured, or if the left image is captured after the threshold was passed after the right image had been captured, the difference between the left image and the right image can be great and the resolution of the synthesized stereoscopic image might be inferior.

When it is determined that the shutter speed does not satisfy the threshold, the process proceeds to operation 555. Otherwise, when it is determined that the shutter speed satisfies the threshold, the process proceeds to operation 560.

In operation 555, the control unit 180 changes an image capturing setting so as to cause the shutter speed to be lower than or equal to the particular reference time value. For example, the control unit 180 may change at least one of an aperture, a shutter, and an ISO value of the camera module 160.

In operation 560, the control unit 180 determines whether an image capturing request is received. The image capturing request may be generated by the user, or may be generated within a predetermined time period by executing the application which executes stereoscopic image capturing.

In operation 570, the control unit 180 successively acquires a left image and a right image, generates a stereoscopic image based on the acquired left and right images, and stores the generated stereoscopic image.

Specifically, when the control unit 180 of the electronic device 100 delivers a signal for acquiring a stereoscopic image to the auxiliary apparatus 200 for capturing a stereoscopic image through the communication unit 110 and the communication unit 210, the control unit 230 of the auxiliary apparatus 200 for capturing a stereoscopic image controls the light delivery portion 252 to cause a left image and a right image to become alternately incident on the image-capturing lens 162.

In some implementations, the light delivery portion 252 separates the left image from the right image by using at least one of an optical method, a physical method, an electrical method and a magnetic method, and enables the left image and the right image, which are separated from each other, to be alternately incident on the image-capturing lens 162.

In some instances, the light delivery portion 252 may be formed in a structure of a triangle. Specifically, in the structure of the triangle, the light delivery portion 252 allows a left image, which has been incident through a left side of the triangle, to be incident on the image-capturing lens 162 via a bottom side of the triangle, and allows a right image, which has been incident through a right side of the triangle, to be incident on the image-capturing lens 162 via the bottom side of the triangle. Here, the left image is an image which has been captured through the left image-capturing hole 262 and is reflected by the left reflector 264 before being reflected to the light delivery portion 252. The right image is an image which has been captured through the right image-capturing hole 272 and is reflected by the right reflector 274 before being reflected to the light delivery portion 252.

The control unit 230 controls the projection of light through each of the left side and the right side of the triangle. Specifically, the control unit 230 may alternately block the left side of the triangle and the right side thereof, according to a frame cycle signal, and may alternately project the left image and the right image, which have been respectively incident through the left side of the triangle and the right side thereof, onto the bottom side of the triangle. At this time, the control unit 230 may block the left side of the triangle and the right side thereof through a physically-rotating mechanical shutter, or may electrically block a signal corresponding to light which has been incident through each of the left side and the right side. For example, when a setting of a recording frame is N frames per second, the control unit 230 performs a control operation for causing light to be alternately incident on the image-capturing lens 162 via the left side and the right side of the light delivery portion 252, so as to store each of a left image and a right image at N/2 frames per second.

In the present example, the control unit 230 may include a variable clock circuit capable of varying a speed, at which light incident through the left side of the light delivery portion 252 and light incident through the right side thereof are alternately projected, by using various internal frame frequencies although the frame signal is not received as input from the outside when a stereoscopic image is captured. Meanwhile, it goes without saying that not only the above-described methods but also various methods may be applied to a case in which the light delivery portion 252 allows the left image and the right image to be incident on the image-capturing lens 162.

Then, the control unit 180 of the electronic device 100 successively acquires the left image and right image which have been incident on the image-capturing lens 162, edits the acquired left and right images into a stereoscopic image, and stores the stereoscopic image in the storage unit 120. Thereafter, the stored stereoscopic image may be displayed on the display unit 150, or may be displayed on the display unit 150, or may be delivered through the connection interface 170 and may be output by the external stereoscopic image output device.

In operation 580, the control unit 180 determines whether a request for exiting the stereoscopic image capturing mode is received. When it is determined in operation 580 that the request for completing the stereoscopic image capturing mode is received, the control unit 180 may complete the connection of communication between the auxiliary apparatus 200 for capturing a stereoscopic image and the electronic device 100, and may complete the driving of the camera module 160. In contrast, when it is determined in operation 580 that the request for completing the stereoscopic image capturing mode is received, the control unit 180 returns to operation 560, and determines whether an image capturing request is received.

In some aspects, the electronic device which is equipped with the above-described the auxiliary apparatus 200 for capturing a stereoscopic image, may further include various additional modules according to a form of implementation thereof. Specifically, when the electronic device 100 is a communication terminal, the electronic device 100 may further include elements which have not been described above, such as a short-range communication module for short-range communication, an interface for transmitting and receiving data in a wired communication scheme or a wireless communication scheme of the communication terminal, an Internet communication module for communicating with an Internet network and performing an Internet function, a digital broadcasting module for receiving and reproducing a digital broadcast signal, and the like. These elements may be variously modified according to the convergence trend of digital devices, and cannot be all enumerated. However, the electronic device 100 may further include elements equivalent to the above-described elements. Also, it goes without saying that, in the terminal 100, particular components may be excluded from the above-described configuration or may be replaced with other components according to a provision form thereof. This may be easily understood by those skilled in the art to which the present disclosure pertains.

In addition, the terminals according to an aspect of the present disclosure may include all information technology devices and multimedia devices such as a Portable Multimedia Player (PMP), a digital broadcasting player, a Personal Digital Assistant (PDA), a music player (for example, an MP3 player), a portable game terminal, a smart phone, a notebook, and a handheld PC and application devices thereof as well as all mobile communication terminals operating based on communication protocols corresponding to various communication systems.

The above-described aspects of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

Meanwhile, although exemplary aspects of the present disclosure have been shown and described in this specification and the drawings, they are used in general sense in order to easily explain technical contents of the present disclosure, and to help comprehension of the present disclosure, and are not intended to limit the scope of the present disclosure. It is obvious to those skilled in the art to which the present disclosure belongs that other modifications can be established without departing from the technical spirit of the present disclosure.

What is claimed is:

1. An apparatus for capturing a stereoscopic image comprising:
a housing having a first image-capturing hole and a second image-capturing hole separated from each other by a predetermined distance, wherein the first image-capturing hole and the second image-capturing hole respectively project a first image and a second image onto a camera module of an electronic device;
a first reflector mounted on one inner wall of the housing for reflecting the first image;
a second reflector mounted on another inner wall of the housing for reflecting the second image; and
a light delivery portion for sequentially delivering the first image and the second image to the camera module.

2. The apparatus of claim 1, wherein the light delivery portion includes a first side, a second side, and a third side arranged in a triangular configuration, wherein:
(i) the third side is substantially parallel to a front surface of the camera module,
(ii) the first image is projected through the first side, and
(iii) the second image is projected through the second side.

3. The apparatus of claim 2, wherein, the light delivery portion includes a physically-rotating shutter that permits each of the first image and the second image to be successively acquired.

4. The apparatus of claim 1, wherein the housing is shaped as a trapezoid, one base of which faces a front surface of the camera module.

5. The apparatus of claim 1, wherein the housing includes a retractable side and the first image-capturing hole and the second image-capturing hole are located in the retractable side.

6. The apparatus of claim 1, wherein the first reflector and the second reflector are tilted by a predetermined angle in a direction of the light delivery portion.

7. The apparatus of claim 1, wherein the apparatus is connected to at least one of an ear jack plug insertion hole and a Universal Serial Bus (USB) connector of the electronic device.

8. A method for capturing a stereoscopic image by using an auxiliary apparatus for capturing the stereoscopic image, the method comprising:
detecting whether the auxiliary apparatus for capturing the stereoscopic image on a front surface of a camera module that is part of an electronic device;
establishing a connection between the electronic device and the auxiliary apparatus for capturing the stereoscopic image;
acquiring a first image and a second image via the auxiliary apparatus for capturing the stereoscopic image; and
generating the stereoscopic image based on the first image and second image.

9. The method of claim 8, wherein the detecting is performed by using a sensor that is part of the electronic device.

10. The method of claim 8, further comprising, detecting whether a shutter speed of the electronic device satisfies a threshold.

11. The method of claim 10, further comprising changing an image capturing setting of the electronic device in response to the shutter speed not satisfying the threshold.

12. The method of claim 8, wherein the connection is established over at least one of a Universal Serial Bus (USB) interface and a Universal Asynchronous Receiver/Transmitter (UART) interface, or through at least one of wireless interfaces according to Bluetooth, Zigbee, Ultra Wide Band (UWB), Radio Frequency IDentification (RFID), Infrared Data Association (IrDA), Wireless Application Protocol (WAP), and Near Field Communication (NFC).
